(19) United States
(12) Patent Application Publication
(10) Pub. No.: US 2006/0213297 A1
(43) Pub. Date: Sep. 28, 2006

(54) Drive system

(75) Inventor: Hartmut Blum, Jena (DE)

Correspondence Address: VENABLE LLP, P.O. BOX 34385, WASHINGTON, DC, 20045-9998, US

(73) Assignee: Elero GmbH, Beuren (DE)

(21) Appl. No.: 11/373,513

(22) Filed: Mar. 13, 2006

(30) Foreign Application Priority Data
Mar. 12, 2005 (DE) 20 2005 003 981.0

(51) Int. Cl. F16H 27/02

(52) U.S. Cl. 74/89.23

(57) ABSTRACT

A drive system includes an electric motor having a rotor and a stator. A nut is rigidly connected to the rotor. A spindle is positioned to be non-rotating and has a drive connection with the nut. A piston rod has one longitudinal end fixed to the spindle, with the spindle extending coaxial to the piston rod. The spindle is driven by the nut in response to rotation of the rotor so that the piston rod executes a linear movement controlled by the electric motor.

### CROSS-REFERENCE TO RELATED APPLICATION

This application claims the priority of German Application DE 20 2005 003 981.0 filed on Mar. 12, 2005, the subject matter of which is incorporated herein by reference.

### BACKGROUND OF THE INVENTION

The present invention relates to a drive system as defined in the preamble to patent claim 1.

Drive systems of this type are used specifically for locking objects. In particular, these drive systems can be used for locking manhole covers. The locking of manhole covers represents an essential safety-technical aspect for increasing the safety of streets. The importance of this area has increased considerably in recent years. The drive systems used consequently must meet high requirements with respect to capacity and operational failure, so that a fail-safe operation for locking manhole covers can be achieved even for longer period of times.

Drive systems of this type can generally be provided with linear-moving elements such as piston rods, which are used for different types of locking processes or other applications.

### SUMMARY OF THE INVENTION

It is the object of the present invention to provide a drive system of the aforementioned type which is extremely reliable while simultaneously having a robust and compact design.

The above and other objects are accomplished according to the invention wherein there is provided a drive system, which in an exemplary embodiment comprises: an electric motor including a rotor and a stator; a spindle nut rigidly connected to the rotor; a spindle positioned to be non-rotating and having a drive connection with the spindle nut; and a piston rod having one longitudinal end fixed to the spindle, the spindle extending coaxial to the piston rod; wherein the spindle is driven by the spindle nut in response to rotation of the rotor so that the piston rod executes a linear movement controlled by the electric motor.

A particularly robust and compact structural design of the drive system according to the invention is obtained when using the spindle nut, which is connected directly and securely with the rotor and drives the spindle for generating the linear movement of the piston rod. The non-rotating positioning of the spindle ensures, in a simple manner, that the rotational movement of the rotor is converted to a purely translational movement of the piston rod.

According to one advantageous embodiment, the nut which drives the spindle is a plastic injection-molded part that is injection-molded onto a rotor shaft which is securely connected to the rotor. This type of embodiment can be produced especially easily and cost-effectively.

According to a different advantageous embodiment of the invention, the piston rod can be displaced between two end positions, wherein limit switches that cooperate with a control cam are provided for controlling the end positions. It is especially advantageous if the control cam, which can be displaced between the limit switches, is used for the non-rotating positioning of the spindle. As a result of this double function of the control cam, the number of parts for the drive system can be reduced, thereby resulting in a reduction of the production costs and, simultaneously, in a compact structural design of the drive system.

To ensure the non-rotating positioning of the spindle, the control cam is usefully attached to one longitudinal end of the spindle and the exposed end of the control cam is embodied as a fork-shaped receptacle, positioned so as to be displaceable along a guide element.

According to a particularly simple and useful embodiment of the invention, the guide element is a fastening screw that connects the housing lid to the housing for the drive system. The double function of the fastening screw, in turn, makes it possible to reduce the number of parts for the drive system according to the invention.

The drive system according to the invention also has a compact and space-saving design with respect to the electrical components. The limit switches are arranged on a circuit board which furthermore contains integrated electrical and electronic components for controlling the drive system, in particular a capacitor for actuating the stator coils. These components are furthermore encapsulated in a plastic outer shell, thus resulting in high electrical insulation protection. In particular, this encapsulation ensures that cables, inserted into the housing by a screw-type conduit fitting, do not extend into the region of the limit switches and the control cam, which could result in undesirable interference with the operation.

According to one particularly advantageous embodiment, the housing for the drive system according to the invention has a water-tight design, up to a predetermined water pressure. This is achieved in particular with the aid of a suitable sealing mechanism to prevent water from entering the housing. It is furthermore advantageous if a dry gel is affixed at predetermined locations to the housing inside, wherein this gel can absorb and bind water that may be present inside of the housing.

In particular, the drive system according to the invention can be used advantageously for locking/unlocking objects, especially manhole covers, wherein the linear piston-rod movement is used for the locking and unlocking operations.

### BRIEF DESCRIPTION OF THE DRAWINGS

These and other features and advantages of the invention will be further understood from the following detailed description of the exemplary embodiments with reference to the accompanying drawings, which show in:

FIG. 1: A three-dimensional representation of an exemplary embodiment of the drive system according to the invention;

FIG. 2: A longitudinal section through the drive system shown in FIG. 1; and

FIG. 3: A perspective representation of the housing for the drive system shown in FIG. 1.

### DETAILED DESCRIPTION OF THE PREFERRED EMBODIMENTS

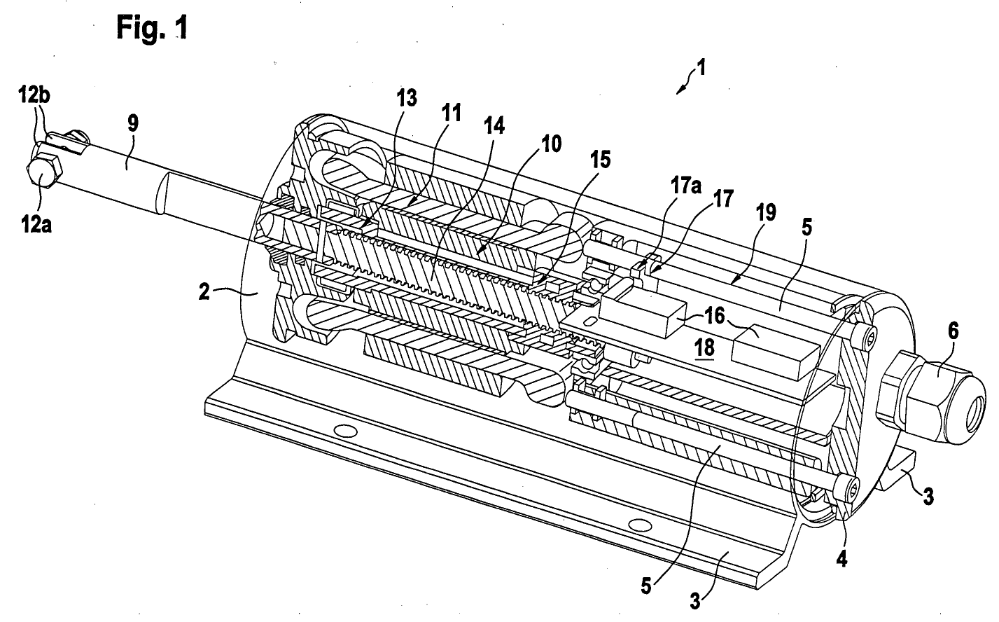

FIGS. 1 to 3 show an exemplary embodiment of a drive system which in the present case is a locking system, in particular used for manhole covers.

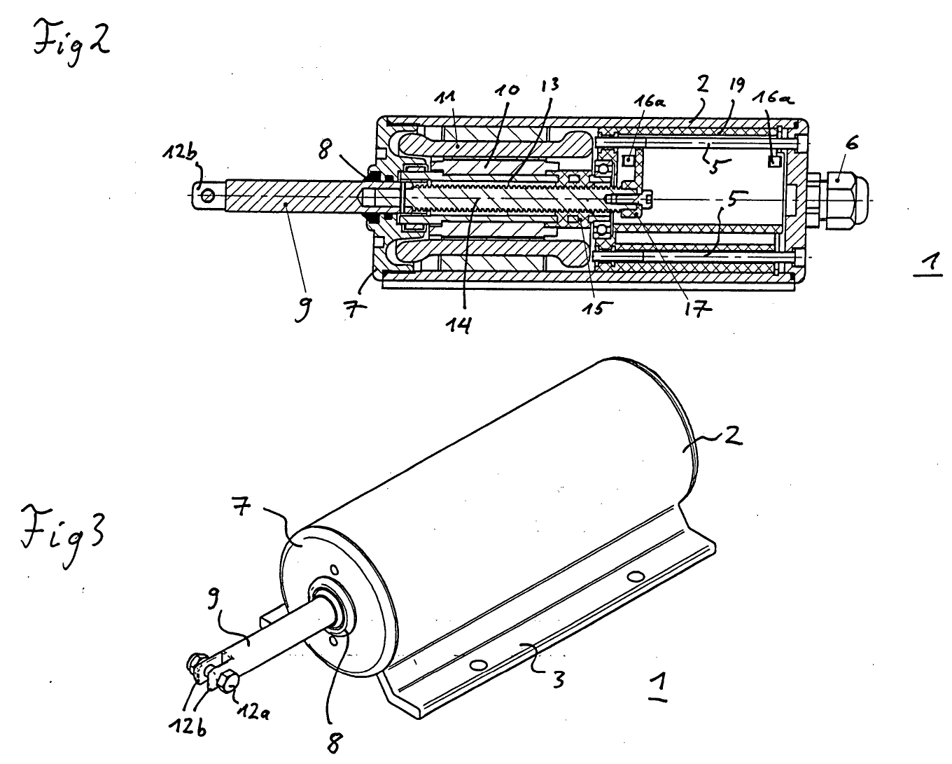

FIG. 1 is a perspective representation of the components of the drive system 1, which are integrated in a housing 2. FIG. 2 shows a longitudinal section through the drive system 1. FIG. 3 shows a perspective view of the housing 2 for the drive system 1.

FIGS. 1 and 3 in particular illustrate that the housing 2 has a hollow-cylindrical shape. Two mounting rails 3 extend outward from the outer shell of housing 2, by which the drive system 1 can be mounted on a base that is not shown herein.

A back end of the housing 2 is closed off with a lid 4, which is screwed to the housing 2 with several fastening screws 5. A screw-type conduit fitting 6 is provided on the housing lid 4, which is used for inserting cables, not shown herein, into the inside of housing 2 to supply power to the drive system 1.

A lid 7 closes off the front end of housing 2, wherein this lid 7 contains a sealing sleeve 8 in the center, inside of which a piston rod 9 is guided.

For executing locking movements, the piston rod 9 can be displaced in a longitudinal direction. An electric motor with a rotor 10 and a stator 11 is integrated into the housing 2 and is used for displacing the piston rod 9 in the longitudinal direction.

The front end of piston rod 9 projects through the front end of housing 2. The exposed end of piston rod 9 is provided with a fastener for attaching the piston rod 9 to the object to be locked, for example, a manhole cover. In the present case, the fastener is a screw 12a, which is positioned in fork-shaped arms 12b of the piston rod 9.

A rotor shaft 13 is compression-molded together with the rotor 10 of the electric motor, so that both components are rigidly connected to each other. The rotor shaft 13 encloses a spindle 14, which extends coaxial to the piston rod 9. The back end of the piston rod 9, which is positioned inside the housing 2, is fixedly connected to the spindle 14. In principle, the spindle 14 and the piston rod 9 can be produced in one piece. The piston rod 9 and the spindle 14 in the present embodiment are connected with the aid of pins, wherein the spindle 14 is embodied as a trapezoidal spindle.

The end of the rotor shaft 13, which faces away from the lid 7 in front, is fixedly connected to a spindle nut 15 that encloses the spindle 14. The nut 15 for the present embodiment is a plastic injection-molded part which is injection-molded onto the rotor shaft 13. The nut 15 drives the spindle 14, thereby causing the piston rod 9 to be displaced in the direction of its longitudinal axis. The spindle 14 is positioned inside the housing 2 to be non-rotating in order to convert the rotational movement of the rotor 10 and the rotor shaft 13, which drive the nut 15, to a purely translational movement of the spindle and the piston rod 9.

In this exemplary embodiment, the spindle 14 and the piston rod 9, can be displaced between two end positions, wherein each end position is controlled by a limit switch 16. The limit switches 16 for the present embodiment are comprise mechanical switches that are activated by a control cam 17. For the activation, the control cam 17 is moved toward a yoke 16a of the respective limit switch 16.

The control cam 17 can move back and forth between the limit positions and, for that purpose, is screwed to the back end of spindle 14. As soon as the control cam 17 engages in one of the limit switches 16, the electric motor is stopped, thereby preventing the piston rod 9 from moving past the respective end position.

The control cam 17 additionally ensures the non-rotating positioning of the spindle 14 and the piston rod 9. The exposed upper end of the control cam 17 is embodied as a fork-shaped receptacle 17a. This fork-shaped receptacle 17a of control cam 17 is guided along one of the fastening screws 5 which serves as a guide element. As a result, the control cam 17 is guided non-rotating and displaceable only in the longitudinal direction along the fastening screw 5.

The limit switches 16 are arranged on a circuit board 18 on which the electronic and/or electrical components for controlling the drive system 1 are integrated as well. In particular, a capacitor is soldered onto the circuit board 18, which capacitor is not shown separately herein and functions to actuate the stator 11 coils.

A plastic outer shell 19 encapsulates the inside region of the housing, in which the circuit board 18 with limit switches 16 for the control cam 17 is arranged. As a result, it is ensured that no cables which might block the movement of the control cam 17 can extend into this region.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A drive system, comprising:
an electric motor including a rotor and a stator;
a nut rigidly connected to the rotor;
a spindle positioned to be non-rotating and having a drive connection with the nut; and
a piston rod having one longitudinal end fixed to the spindle, the spindle extending coaxial to the piston rod;
wherein the spindle is driven by the nut in response to rotation of the rotor so that the piston rod executes a linear movement controlled by the electric motor.

2. The drive system as defined in claim 1, further including a rotor shaft, wherein the rotor encloses and is fixedly connected to a rotor shaft, and the nut is secured on the rotor shaft.

3. The drive system as defined in claim 2, wherein the nut is an injection-molded plastic part that is injection-molded onto the rotor shaft.

4. The drive system as defined in claim 1, further including pins connecting the spindle to the piston rod.

5. The drive system as defined claim 1, wherein the spindle comprises a trapezoidal spindle.

6. The drive system as defined in claim 1, wherein the piston rod is moveable back and forth between two end positions.

7. The drive system as defined in claim 6, further including a separate limit switch to control each end position.

8. The drive system as defined in claim 7, further including a control cam to activate the limit switches.

9. The drive system as defined in claim 8, wherein the control cam is attached to a longitudinal end of spindle facing away from the piston rod.

10. The drive system as defined in claims 8, wherein the control cam ensures the non-rotating positioning of the spindle.

11. The drive system as defined in claim 10, further including a guide element, wherein the control cam has an exposed end comprising a fork-shaped receptacle that is displaceably positioned along the guide element.

12. The drive system as defined in claim 11 combined with a hollow cylindrical housing having a front and a back, wherein the drive system is integrated into the hollow-cylindrical housing with the piston rod projecting past the front of the housing, and further including a lid closing off the back of the housing.

13. The drive system as defined in claim 12, further including a fastening screw that secures the lid to the housing.

14. The drive system as defined in claim 13, wherein one of the fastening screws is exposed in some sections inside the housing and constitutes the guide element for the control cam.

15. The drive system as defined in claim 7, further including a circuit board mounting the limit switches.

16. The drive system as defined in claim 15, further including a drive system control having electronic components arranged on the circuit board.

17. The drive system as defined in claim 16, wherein the electronic components include a capacitor for actuating coils of the stator.

18. The drive system as defined in claim 15 combined with a housing surrounding the drive system, wherein an inside region of the housing is encapsulated by a plastic outer shell, and the circuit board with limit switches and the control cams are arranged inside the shell.

19. The drive system as defined in claim 12, further including a frontal lid closing off the front of the housing.

20. The drive system as defined in claim 19, further including a sealing sleeve disposed in a center of the frontal lid for guiding the piston rod which projects over the front of the housing.

21. The drive system as defined in claim 1, wherein the piston rod includes a locking element.

22. The drive system as defined in claim 21, wherein the piston has a frontal, exposed end that includes a fastening mechanism for attaching the piston to a manhole cover.
